(19) United States
(12) Patent Application Publication
(10) Pub. No.: US 2018/0224724 A1
(43) Pub. Date: Aug. 9, 2018

(54) SLIDING BLOCK OF ANGLE-ADJUSTABLE PHOTOGRAPHIC SLIDING RAIL

(71) Applicant: Zhongshan Dashan Photographic Equipment Co., Ltd., Zhongshan (CN)

(72) Inventors: Xihua Zhu, Zhongshan (CN); Shuang Xiao, Zhongshan (CN)

(21) Appl. No.: 15/588,734

(22) Filed: May 8, 2017

Related U.S. Application Data
(63) Continuation of application No. PCT/CN2017/075094, filed on Feb. 28, 2017.

(30) Foreign Application Priority Data
Feb. 9, 2017 (CN) 201710071625.0

(51) Int. Cl. G03B 17/56; F16M 11/10; F16M 11/20

(52) U.S. Cl. CPC G03B 17/561; F16M 2200/024; F16M 11/2085; F16M 11/10

(57) ABSTRACT

A sliding block of an angle-adjustable photographic sliding rail comprises a sliding block body, an angle adjustment plate having one end swingingly connected on the sliding block body via a rotating shaft, and a stepless adjustment strutting structure arranged between the sliding block body and the angle adjustment plate. When the photographic sliding rail cannot be put in place and needs to be tilted for use, the stepless adjustment strutting structure can be loosened first, and then the angle adjustment plate can be swung and opened such that a lens of a camera or video camera on the angle adjustment plate is at a horizontal position, to achieve the angle adjustment of the angle adjustment plate.

### CROSS REFERENCE TO RELATED APPLICATIONS

This application is a continuation of PCT Application No. PCT/CN2017/075094, filed on Feb. 28, 2017, which claims priority to Chinese Patent Application No. 201710071625.0, filed on Feb. 9, 2017, the entire contents of which are incorporated herein by reference.

### TECHNICAL FIELD

The present invention relates to photographic equipments, and in particular to a photographic sliding rail.

### BACKGROUND

We know current moveable type photographic sliding rail available on the market has a sliding block mounted on a guide rail for placing a camera; since the surface of the sliding block is always in a horizontal plane with the guide rail, when the photographic sliding rail is tilted, the sliding block is also tilted with the sliding rail. If a camera is mounted on the sliding block at this time, the camera is caused to be tilted too. As we know, when the camera is in moving shooting, the lens is required to be kept in a horizontal state substantially. Therefore, when the sliding rail is tilted, an additional angle adjustment plate is required for correction so as to place the lens in a horizontal position. Therefore, people often need to carry an additional horizontal adjustment tripod head while carrying a moveable type photographic sliding rail, this not only results in inconvenient carrying, but also the assembly and disassembly of the horizontal adjustment tripod head will greatly delay the best time for shooting when the sliding rail needs to be set up quickly to shoot.

### SUMMARY

The present invention aims to overcome the drawbacks in the existing technologies and provide a sliding block of an angle-adjustable photographic sliding rail, which has a reasonable structure, so that an additional horizontal adjustment tripod head is no longer needed, without repeated assembly and disassembly of the horizontal adjustment tripod head which results in cumbersome operation of the photographic sliding rail and delay the best time for shooting.

In order to solve the above existing technical problem, the disclosure adopts a technical scheme as follows.

A sliding block of an angle-adjustable photographic sliding rail includes a sliding block body, an angle adjustment plate having one end swingingly connected to the sliding block body via a rotating shaft, and a stepless adjustment strutting structure arranged between the sliding block body and the angle adjustment plate.

In a modified embodiment of the above sliding block of angle-adjustable photographic sliding rail, the stepless adjustment strutting structure includes a strut rod with one end thereof swingingly connected to the angle adjustment plate, a bolt penetrating through a horizontal hole of the sliding block body and a strip-shaped hole on the other end of the strut rod, and a tilted locking knob screwed on the bolt to lock the adjustment plate that is in an open state.

In a modified embodiment of the above sliding block of angle-adjustable photographic sliding rail, a horizontal locking plate structure used for locking the angle adjustment plate in a horizontal state is arranged on the sliding block body.

In a modified embodiment of the above sliding block of angle-adjustable photographic sliding rail, the horizontal locking plate structure includes a horizontal lock catch vertically swingingly connected in an open slot of the sliding block body, and a lock catch spring for urging the horizontal lock catch in proper place to buckle the angle adjustment plate.

Compared with the existing technologies, the disclosure has the advantages as follows: as the angle adjustment plate is swingingly connected to one end of the sliding block body, and the stepless adjustment strutting structure is arranged between the sliding block body and the angle adjustment plate, when the photographic sliding rail cannot be put in place and needs to be tilted for use, the stepless adjustment strutting structure can be loosened first, and then the angle adjustment plate can be swung and opened to place the lens of a camera or video camera on the angle adjustment plate at a horizontal position, to achieve the angle adjustment of the angle adjustment plate. Therefore, when people use the angle-adjustable photographic sliding rail, there is no need to carry an additional horizontal adjustment tripod head, and thus will not delay the best time for shooting caused by repeated assembly and disassembly of the horizontal adjustment tripod head. The disclosure has a reasonable structure, and, when it is applied to a photographic sliding rail, a photographing lens can be ensured to be always in a horizontal state by adjusting the sliding block.

### BRIEF DESCRIPTION OF THE DRAWINGS

The disclosure is described below in further detail in conjunction with accompanying drawings and specific embodiments.

FIG. 1 is a first perspective view of the embodiment of the disclosure mounted on a photographic sliding rail.

FIG. 2 is a second perspective view of the embodiment of the disclosure mounted on the photographic sliding rail.

FIG. 3 is an assembly view of the embodiment of the disclosure.

FIG. 4 is a schematic diagram of a horizontal locking plate structure of the embodiment of the disclosure.

### DETAILED DESCRIPTION

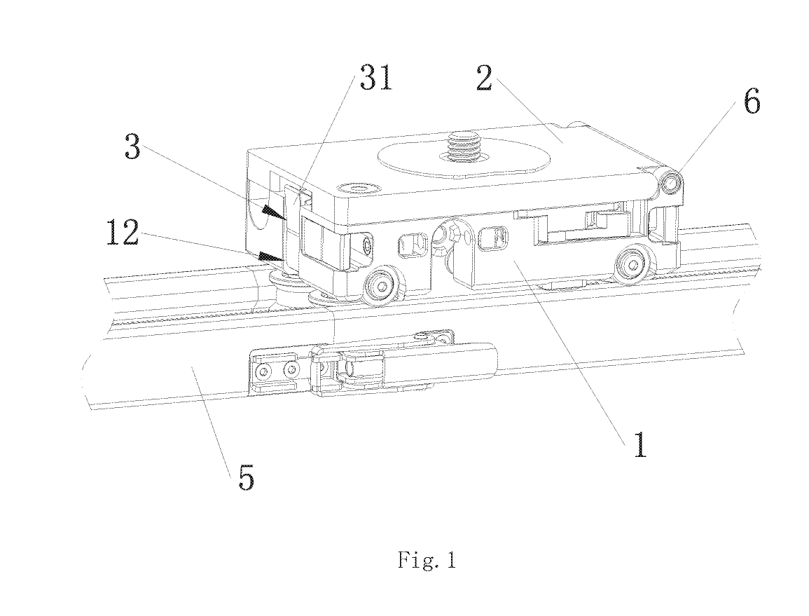

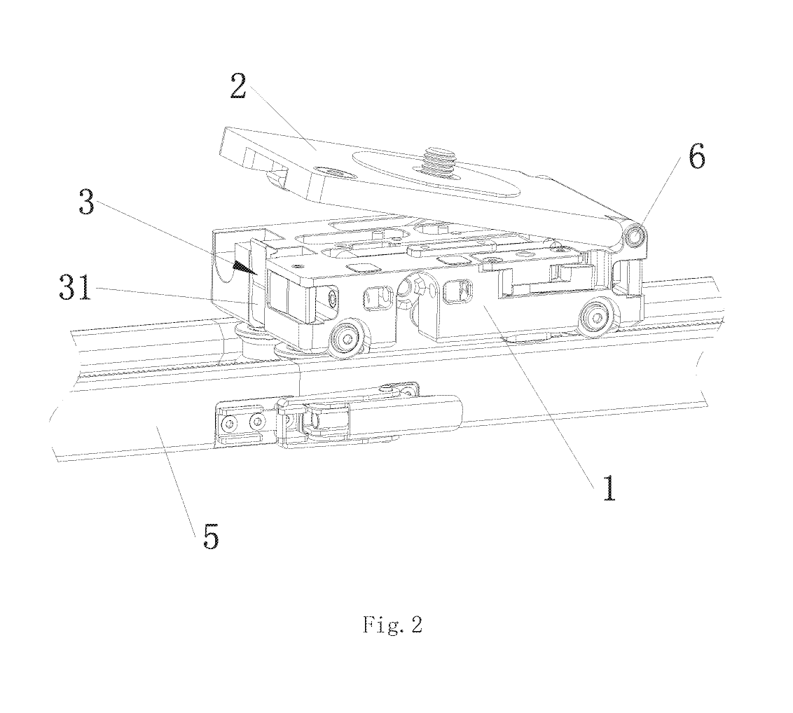

The present invention is a sliding block of an angle-adjustable photographic sliding rail, as shown in FIG. 1 to FIG. 4, including a sliding block body 1, an angle adjustment plate 2 having one end swingingly connected to the sliding block body 1 through a rotating shaft 6, and a stepless adjustment strutting structure 4 arranged between the sliding block body 1 and the angle adjustment plate 2. When a photographic sliding rail 5 installed with this photographic sliding block is in used, a camera or video camera is mounted on the angle adjustment plate 2, at this time if the sliding rail cannot be put in place and needs to be tilted for use, the stepless adjustment strutting structure 4 can be loosened, then the angle adjustment plate 2 can be swung and opened, and, when a lens of the camera or video camera on the angle adjustment plate is adjusted to a horizontal position, the stepless adjustment strutting structure 4 is tightened, to achieve the angle adjustment of the angle adjustment plate 2. From the above, it can seen that, when people use a photographic sliding rail installed with the sliding block of an angle-adjustable photographic sliding rail, there is no need to carry an additional horizontal adjustment tripod head, and thus will not delay the best time for shooting caused by the repeated assembly and disassembly of the horizontal adjustment tripod head; therefore, the present invention has a reasonable structure, and, when it is applied to a photographic sliding rail, a photographing lens can be ensured to be always in a horizontal state by adjusting the sliding block.

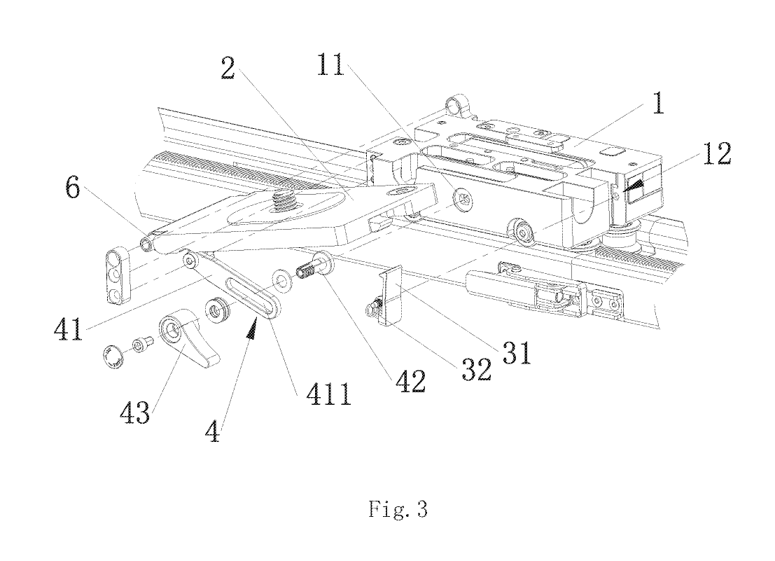

In this embodiment, as shown in FIG. 3, the stepless adjustment strutting structure 4 includes a strut rod 41 with one end swingingly connected to the angle adjustment plate 2, a bolt 42 penetrating through a horizontal hole 11 of the sliding block body 1 and a strip shaped hole 411 on the other end of the strut rod 41, and a tilted locking knob 43 screwed on the bolt 42 to lock the adjustment plate that is in an open state. During operations, the tilted locking knob 43 is turned first to loosen the bolt 42, such that the angle adjustment plate 2 can be opened. With the strip shaped hole 411 of the strut rod 41 slides along the bolt 42, the stepless adjustment can be achieved. When the angle adjustment plate 2 is opened to a desired angle, the tilted locking knob 43 is reversely turned to tighten the bolt 42, so as to lock the adjustment plate. Of course, the stepless adjustment strutting structure 4 also may be of other structures, for example, opening an retractable adjustment plate by way of, similar to, jack.

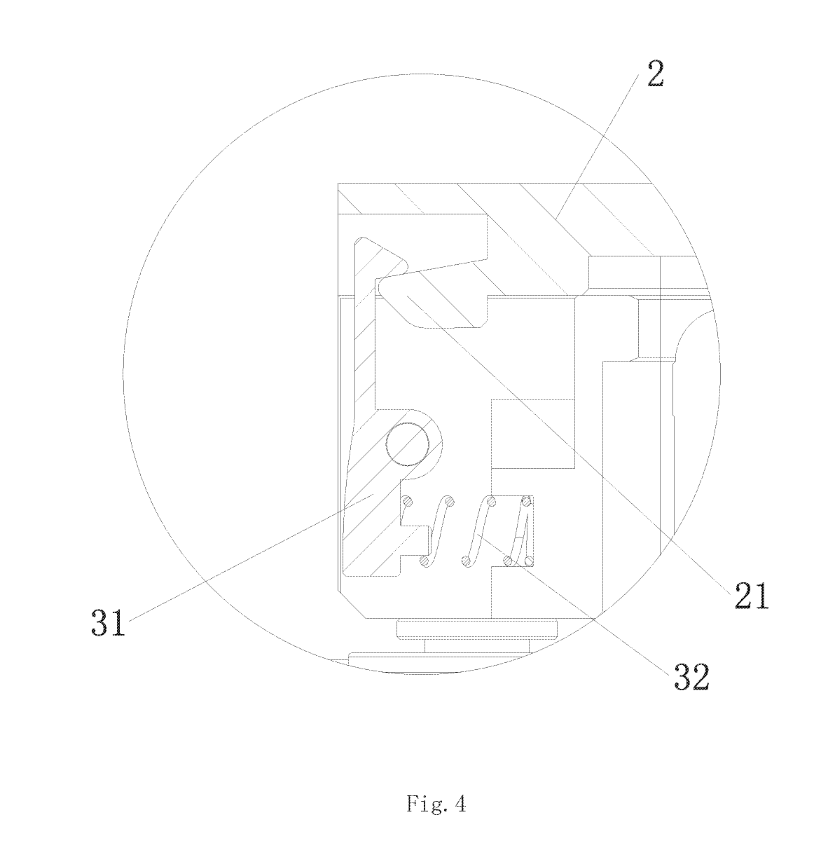

Preferably, a horizontal locking plate structure 3 for locking the angle adjustment plate 2 in a horizontal state is arranged on the sliding block body 1. During manipulating the stepless adjustment strutting structure 4, it is need to operate the horizontal locking plate structure 3 firstly so as to release the locking of the angle adjustment plate 2, and then to loosen the stepless adjustment strutting structure 4 to implement angle adjustment. In this embodiment, as shown in FIG. 3 and FIG. 4, the horizontal locking plate structure 3 includes a horizontal lock catch 31 vertically swingingly connected in an open slot 12 of the sliding block body 1, and a lock catch spring 32 for putting the horizontal lock catch 31 in place to buckle the angle adjustment plate 2. During unlocking, the lower end of the horizontal lock catch 31 is pressed to make its hook part disengage from a hook platform 21 of the adjustment plate, and then the horizontal locking of the adjustment plate is released.

The above descriptions are merely preferred embodiments of the disclosure and are not intended to limit the implementation scope of the disclosure. All equivalent changes and modifications made according to the content within the patent scope claimed by the disclosure are intended to be included in the technical scope of the disclosure.

What is claimed is:

1. A sliding block of an angle-adjustable photographic sliding rail, wherein the sliding block of an angle-adjustable photographic sliding rail comprises a sliding block body (1), an angle adjustment plate (2) having one end swingingly connected to the sliding block body (1) via a rotating shaft (6), and a stepless adjustment strutting structure (4) arranged between the sliding block body (1) and the angle adjustment plate (2).

2. The sliding block of an angle-adjustable photographic sliding rail according to claim 1, wherein the stepless adjustment strutting structure (4) comprises a strut rod (41) with one end swingingly connected to the angle adjustment plate (2), a bolt (42) penetrating through a horizontal hole (11) of the sliding block body (1) and a strip shaped hole (411) on the other end of the strut rod (41), and a tilted locking knob (43) screwed on the bolt (42) to lock the adjustment plate that is in an open state.

3. The sliding block of an angle-adjustable photographic sliding rail according to claim 1, wherein a horizontal locking plate structure (3) used for locking the angle adjustment plate (2) that is in a horizontal state is arranged on the sliding block body (1).

4. The sliding block of an angle-adjustable photographic sliding rail according to claim 2, wherein a horizontal locking plate structure (3) used for locking the angle adjustment plate (2) that is in a horizontal state is arranged on the sliding block body (1).

5. The sliding block of an angle-adjustable photographic sliding rail according to claim 3, wherein the horizontal locking plate structure (3) comprises a horizontal lock catch (31) vertically swingingly connected in an open slot (12) of the sliding block body (1), and a lock catch spring (32) used for urging the horizontal lock catch (31) in proper place to buckle the angle adjustment plate (2).

6. The sliding block of an angle-adjustable photographic sliding rail according to claim 4, wherein the horizontal locking plate structure (3) comprises a horizontal lock catch (31) vertically swingingly connected in an open slot (12) of the sliding block body (1), and a lock catch spring (32) used for urging the horizontal lock catch (31) in proper place to buckle the angle adjustment plate (2).
